(19) United States
(12) Patent Application Publication
(10) Pub. No.: US 2002/0172852 A1
(43) Pub. Date: Nov. 21, 2002

(54) Flow field plate for a fuel cell and fuel cell assembly incorporating the flow field plate

(76) Inventors: David Frank, Scarborough (CA); Joseph Cargnelli, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 09/855,018

(22) Filed: May 15, 2001

(51) Int. Cl. H01M 8/02; H01M 8/10

(52) U.S. Cl. 429/34; 429/32

(57) ABSTRACT

A flow field plate for a fuel cell has, on the front side thereof, flow channels for a reactant gas. At least two slots extending from the front thereof to the rear side. On the rear side, for each of the two apertures for the reactant gas, there is an aperture extension, providing a flow path from each aperture to a respective slot. The enables sealing surfaces, on the two surfaces to be offset so as to be fully supported, and to be located on opposite sides of corresponding slots. The arrangement avoids having to provide seal or gasket portions crossing flow channels and ensures that all portions of each gasket are properly supported.

### FIELD OF THE INVENTION

This invention relates to fuel cells, to a flow field plate for a fuel cell and to a fuel cell assembly incorporating the flow field plate. This invention more particularly is concerned with an apparatus and a method of sealing a stack between different flow field plates and other elements of a conventional fuel cell or fuel stack assembly, to prevent leakage of gases and liquids required for operation of the individual gases and to feed the reactant into the active areas of the stack of fuel cells.

### BACKGROUND OF THE INVENTION

There are various known types of fuel cells. One form of fuel cell that is currently believed to be practical for usage in many applications is a fuel cell employing a proton exchange membrane (PEM) A PEM fuel cell enables a simple, compact fuel cell to be designed, which is robust, which can be operated at temperatures not too different from ambient temperatures and which does not have complex requirements with respect to fuel, oxidant and coolant supplies.

Conventional fuel cells generate relative low voltages. In order to provide a useable amount of power, fuel cells are commonly configured into fuel cell stacks, which typically may have 10, 20, 30 or even 100's of fuel cells in a single stack. While this does provide a single unit capable of generating useful amounts of power at usable voltages, the design can be quite complex and can include numerous elements, all of which must be carefully assembled.

For example, a conventional PEM fuel cell requires two flow field plates, an anode flow field plate and a cathode flow field plate. A membrane electrode assembly (MEA), including the actual proton exchange membrane is provided between the two plates. Additionally, a gas diffusion media (GDM) is provided, sandwiched between each flow field plate and the proton exchange membrane. The gas diffusion media enables diffusion of the appropriate gas, either the fuel or oxidant, to the surface of the proton exchange membrane, and at the same time provides for conduction of electricity between the associated flow field plate and the PEM

This basic cell structure itself requires two seals, each seal being provided between one of the flow field plates and the PEM. Moreover, these seals have to be of a relatively complex configuration. In particular, as detailed below, the flow field plates, for use in the fuel cell stack, have to provide a number of functions and a complex sealing arrangement is required.

For a fuel cell stack, the flow field plates typically provide apertures or openings at either end, so that a stack of flow field plates then define elongate channels extending perpendicularly to the flow field plates. As a fuel cell requires flows of a fuel, an oxidant and a coolant, this typically requires three pairs of ports or six ports in total. This is because it is necessary for the fuel and the oxidant to flow through each fuel cell. A continuous flow through ensures that, while most of the fuel or oxidant as the case may be is consumed, any contaminants are continually flushed through the fuel cell.

The foregoing assumes that the fuel cell would be a compact type of configuration provided with water or the like as a coolant. There are known stack configurations, which use air as a coolant, either relying on natural convection or by forced convection. Such cell stacks typically provide open channels through the stacks for the coolant, and the sealing requirements are lessened. Commonly, it is then only necessary to provide sealed supply channels for the oxidant and the fuel.

Consequently, each flow field plate typically has three apertures at each end, each aperture representing either an inlet or outlet for one of fuel, oxidant and coolant. In a completed fuel cell stack, these apertures align, to form distribution channels extending through the entire fuel cell stack. It will thus be appreciated that the sealing requirements are complex and difficult to meet. However, it is possible to have multiple inlets and outlets to the fuel cell for each fluid depending on the stack/cell design. For example, some fuel cells have 2 inlet ports for each of the anode, cathode and coolant, 2 outlet ports for the coolant and only 1 outlet port for each of the cathode and anode. However, any combination can be envisioned.

For the coolant, this commonly flows across the back of each fuel cell, so as to flow between adjacent, individual fuel cells. This is not essential however and, as a result, many fuel cell stack designs have cooling channels only at every 2nd, 3rd or 4th (etc.) plate. This allows for a more compact stack (thinner plates) but may provide less than satisfactory cooling. This provides the requirement for another seal, namely a seal between each adjacent pair of individual fuel cells. Thus, in a completed fuel cell stack, each individual fuel cell will require two seals just to seal the membrane exchange assembly to the two flow field plates. A fuel cell stack with 30 individual fuel cells will require 60 seals just for this purpose. Additionally, as noted, a seal is required between each adjacent pair of fuel cells and end seals to current collectors. For a 30 cell stack, this requires an additional 31 seals, thus, a 30 cell stack would require a total of 91 seals (excluding seals for the bus bars, current collectors and endplates), and each of these would be of a complex and elaborate construction. With the additional gaskets required for the bus bars, insulator plates and endplates the number reaches 100 seals, of various configurations, in a single 30 cell stack.

Commonly the seals are formed by providing channels or grooves in the flow field plates, and then providing prefabricated gaskets in these channels or grooves to effect a seal. In known manner, the gaskets (and/or seal materials) are specifically polymerized and formulated to resist degradation from contact with the various materials of construction in the fuel cell, various gasses and coolants which can be aqueous, organic and inorganic fluids used for heat transfer. Reference to a resilient seal here refers typically to a floppy gasket seal molded separately from the individual elements of the fuel cells by known methods such as injection, transfer or compression molding of elastomers. By known methods, such as insert injection molding, a resilient seal can be fabricated on a plate, and clearly assembly of the unit can then be simpler, but forming such a seal can be difficult and expensive due to inherent processing variables such as mold wear, tolerances in fabricated plates and material changes. In addition custom made tooling is required for each seal and plate design.

A fuel cell stack, after assembly, is commonly clamped to secure the elements and ensure that adequate compression is applied to the seals and active area of the fuel cell stack. This method ensures that the contact resistance is minimized and the electrical resistance of the Cells is at a minimum. To this end, a fuel cell stack typically has two substantial end plates, which are configured to be sufficiently rigid so that their deflection under pressure is within acceptable tolerances. The fuel cell also typically has current bus bars to collect and concentrate the current from the fuel cell to a small pick up point and the current is then transferred to the load via conductors. Insulation plates may also be used to isolate, both thermally and electrically, the current bus bars and endplates from each other. A plurality of elongated rods, bolts and the like are then provided between the pairs of plates, so that the fuel cell stack between the plates, tension rods can be clamped together. Rivets, straps, piano wire, metal plates and other mechanisms can also be used to clamp the stack together. To assemble the stack, the rods are provided extending through one of the plates, an insulator plate and then a bus bar (including seals) are placed on top of the endplate, and the individual elements of the fuel cell are then built up within the space defined by the rods or defined by some other positioning tool This typically requires, for each fuel cell, the following steps:

(a) placing a seal to separate the fuel cell from the preceding fuel cell;

(b) locating a flow field plate on the seal;

(c) locating a seal on the first flow field plate;

(d) placing a GDM within the seal on the flow field plate;

(e) locating a membrane electrode assembly (MEA) on the seal;

(f) placing an additional GDM on top of the MEA;

(g) preparing a further flow field plate with a seal and placing this on top of the membrane exchange assembly, while ensuring the seal of the second plate falls around the second GDM;

(h) this second or upper flow field plate then showing a groove for receiving a seal, as in step (a).

This process needs to be completed until the last cell is formed and it is then topped off with a bus bar, insulator plate and the final end plate.

A problem in many fuel cell designs is that each flow field plate, necessarily, must have a network of flow field channels in communication with supply apertures defining the distribution channels for the appropriate fluid. Almost always, fuel cells are designed to provide flow through of reaction gases, to prevent build-up of impurities. Thus, for the reaction gases and coolant, each network of flow field channels is connected to at least two apertures or ports. Yet, at the same time, many designs require a seal to be provided between each flow field plate and the MEA, enclosing the MEA, and most importantly, providing a seal between the active area of the MEA and the apertures or ports. This requires a seal or gasket to pass over the flow field channel or connection portions proving a connection between the supply apertures and the main central or active portion of the flow field channels.

For any one reaction gas it is conceivable to provide a gasket completing enclosing all of the flow field channels and the supply apertures on the corresponding, first flow field plate. This will enable a good seal to be formed between that flow field plate and the MEA. However, on the other side of the MEA, it is necessary to provide a gasket completely encircling the aperture in a second flow field plate, for the reaction gas supplied to the first flow field plate. In this configuration, part of the membrane would lie over open channels on the first flow field plate, and hence not be properly supported, thereby running the risk of there being inadequate sealing, resulting in a mixing of gases, which as is known is highly undesirable.

The other alternative is to provide a gasket on the first flow field plate that crosses over the grooves or channels. This then provides some support for the MEA, which is then sandwiched between the two similarly configured gaskets. However, where the gasket crosses over the open channels on the first flow field plate, the gasket will not be property supported, which can cause two problems. Firstly, lack of support for the gasket may result in improper sealing to the MEA. Secondly, the gasket may tend to protrude down into the flow channels, impeding flow of the gas.

A Many older designs did not address this problem and simply assumed that any unwanted deflection of a gasket into a flow field channels would not cause significant difficulties. Consequently, the gasket once compressed could collapse into the connection portions of the channels, at least partially blocking the channels, and as noted, simultaneously there may be an adequate pressure applied to the MEA, causing failure of the seal on one side of the MEA or the other.

This problem has been identified and addressed in U.S. Pat. No. 6,017,648. This notes that an older technique, greatly complicating the manufacture of flow field plates, requires the drilling of individual bores from the supply apertures to the main portion of the flow field channels, effectively ensuring that the connection channel portions are enclosed. This U.S. patent proposes an alternative technique; the flow field channels are entirely open, but bridge pieces are provided to enclose the connection channel portions and it thereby provides support for the gaskets. This technique is still complex, increases the number of parts, making fuel cell stack assembly even more complex, and there is the problem of ensuring that all the bridge pieces are property located during assembly and remain in location after assembly. Additionally, if inadequate tolerances are maintained on the various components, the bridge pieces may not be totally flush with the top of the flow field plate, again leading to improper sealing of the gasket, or excess local pressure leading to damage of the flow field plate. Also, the assignee of the present invention had previously developed a similar arrangement, providing “bridge” pieces, to prevent gaskets collapsing into flow channels.

Thus, it will be appreciated that assembling a conventional fuel cell stack is difficult, time consuming, and can often lead to sealing failures. The technique taught in U.S. Pat. No. 6,017,648, to a large extent, merely substitutes one problem for another.

For all these reasons, manufacture and assembly of conventional fuel cells is time consuming and expensive More particularly, present assembly techniques are entirely unsuited to large-scale production of fuel cells on a production line basis.

### SUMMARY OF THE INVENTION

In accordance with the present invention, there is provided a flow field plate for a fuel cell, the flow field plate having a front side, for defining a chamber with a complementary flow field plate for a membrane electrode assembly, and a rear side, the flow field plate including:

at least two apertures for a reactant gas for supply to said chambers;

on the front side thereof, reactant gas flow field channels;

for each of the apertures, an aperture extension extending on the rear side of the flow field plate;

for each aperture, at least one slot extending through the flow field plate from the back side to the front side thereof, to provide communication between the corresponding aperture extension and the reactant action gas flow channels.

In accordance with another aspect of the present invention, there is provided a fuel cell assembly including at least one fuel cell, wherein each fuel cell comprises:

first and second complementary flow field plates including a front sides and rear side, with the front surfaces facing one another and defining a fuel cell chamber;

a membrane electrode assembly and gas diffusion media provided within the fuel cell chamber;

at least two first apertures in each flow field plate for a first reactant gas and at least two second apertures in each flow field plate for a second reactant gas;

wherein the first flow field plate includes: first reactant gas flow channels on the front side thereof; first slots extending from the first reactant gas flow channels to the rear side thereof, for each of the first apertures thereof, on the rear site thereof, a first aperture extension, providing communication between the first apertures thereof and said first slots; and

wherein the second flow field plate includes: second reactant gas flow channels on the front side thereof; second slots extending from the second reactant gas flow channels to the rear side thereof, for each of the second apertures thereof, on the rear side thereof, a second aperture extension, providing communication between the second apertures thereof and said second slots.

### BRIEF DESCRIPTION OF THE DRAWINGS

For a better understanding of the present invention and to show more clearly how it may be carried into effect, reference will now be made, by way of example, to the accompanying drawings which show, by way of example, a preferred embodiment of the present invention and in which:

FIG. 1 shows an isometric view of a fuel cell stack in accordance with the present invention;

FIG. 2 shows an isometric exploded view of the fuel cell stack of FIG. 1, to show individual components thereof;

FIGS. 3 and 4 show, respectively, front and rear views of an anode bipolar flow field plate of the fuel cell stack of FIGS. 5 and 6;

FIG. 5 shows a plan view on an enlarged scale of the portion 5 of FIG. 4, showing one supply aperture in greater detail;

FIG. 6a shows a perspective view of the supply aperture of FIG. 5, in a partial section and showing adjacent elements of the fuel cell stack;

FIG. 6b show a perspective view similar to FIG. 6a, but on a larger scale;

FIGS. 7 and 8 show, respectively, front and rear views of a cathode bipolar flow field plate of the fuel cell stack of FIGS. 1 and 2;

FIG. 9 shows a plan view on an enlarged scale of the portion 9 of FIG. 8, showing one supply aperture in greater detail;

FIG. 10a shows a perspective view of the supply aperture of FIG. 9, in partial section and showing adjacent elements of the fuel cell stack;

FIG. 10b shows a perspective view similar to FIG. 10b, but in a larger scale;

FIG. 11 shows a rear view of an anode end plate;

FIG. 12 shows a view, on a larger scale, of a detail 12 of FIG. 11; and

FIG. 13 shows a cross-sectional view along the lines 13 of FIG. 12.

FIG. 14 shows a rear view of a cathode end plate; and

FIG. 15 shows a view, on a larger scale, of a detail 15 of FIG. 14.

### DETAILED DESCRIPTION OF THE INVENTION

Conventionally, for each pair of grooves of two facing plates in a fuel cell, some form of preformed gasket will be provided. Now, in accordance with an invention disclosed in U.S. patent application Ser. No. ______, the various grooves could be connected together by suitable conduits to form a continuous groove or channel Then, a seal material is injected through these various grooves, so as to fill the grooves entirely. The sealant is then cured, e.g. by subjecting it to a suitable elevated temperature, to form a complete seal. Both sealing techniques, or any other suitable sealing technique, can be used in a fuel stack of the present invention.

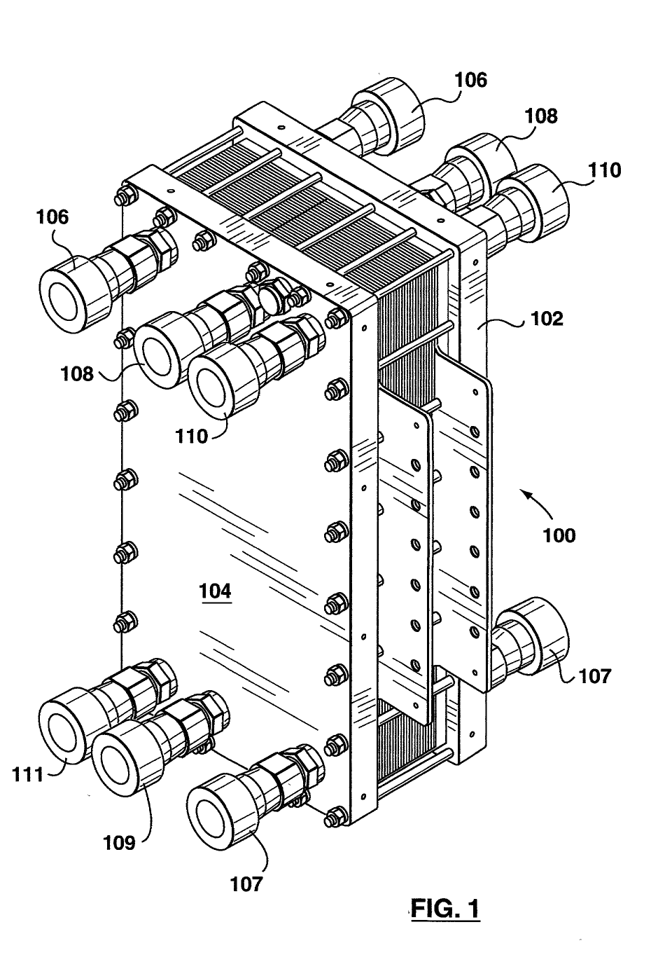

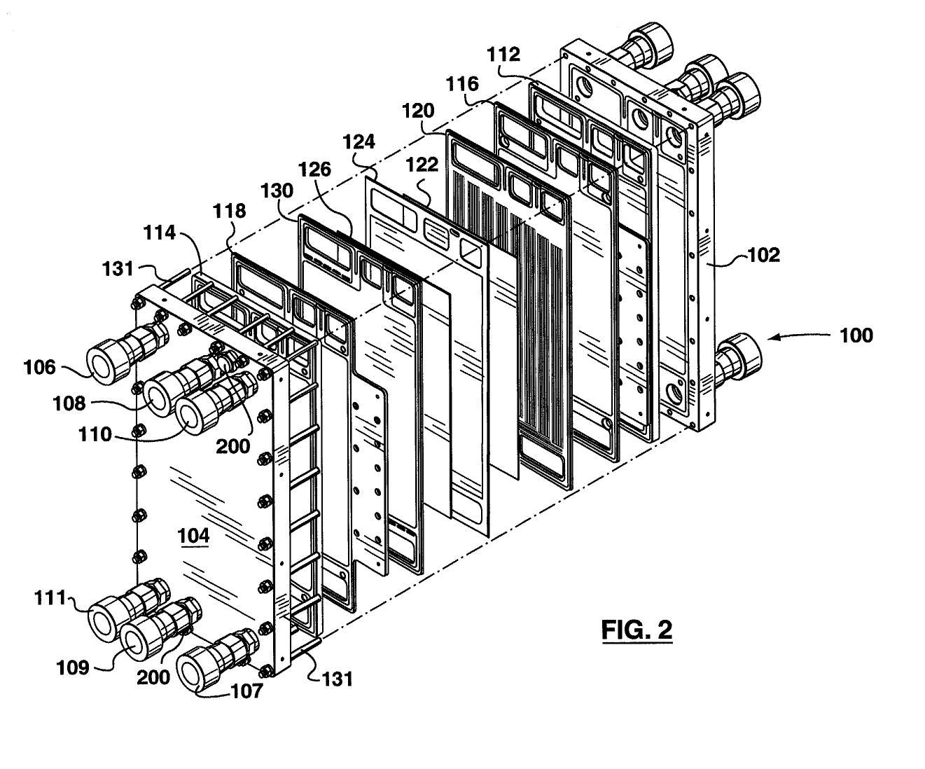

Referring first to FIGS. 1 and 2, there are shown the basic elements of the stack 100 Thus, the stack 100 includes an anode endplate 102 and cathode endplate 104. In known manner, the endplates 102, 104 are provided with connection ports for supply of the necessary fluids. Air connection ports are indicated at 106, 107; coolant connection ports are indicated at 108, 109; and hydrogen connection ports are indicated at 110, 111. Although not shown, it will be understood that corresponding coolant and hydrogen ports, corresponding to ports 109, 111 would be provided on the anode side of the fuel cell stack. The various ports 106-111 are connected to distribution channels or ducts that extend through the fuel cell stack, as for the earlier embodiments. The ports are provided in pairs and extend all the way through the fuel cell stack, to enable connection of the fuel cell stack to various equipment necessary. This also enables a number of fuel cell stacks to be connected together, in known manner.

Immediately adjacent the anode and cathode endplates 102, 104, there are insulators 112 and 114. Immediately adjacent the insulators, in known manner, there are an anode current collector 116 and a cathode current collector 118.

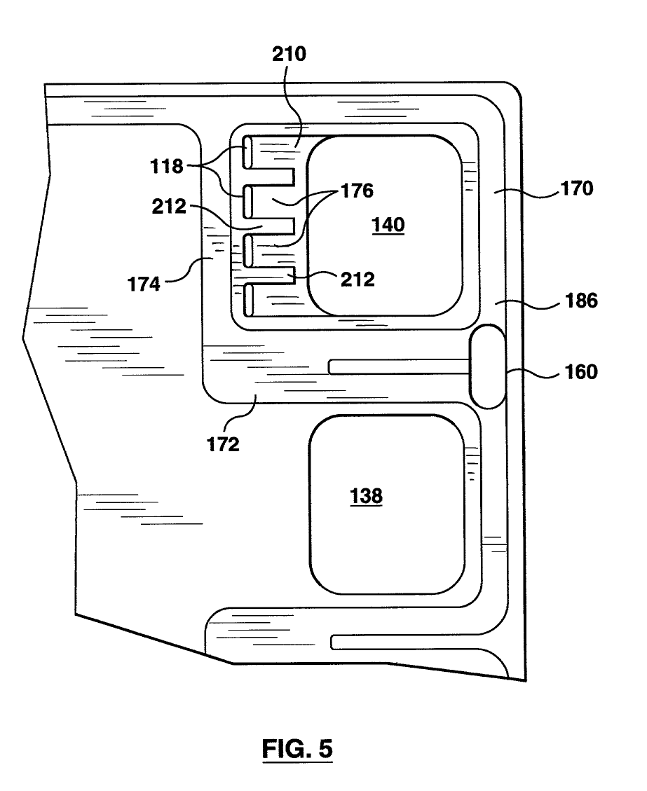

Between the current collectors 116, 118, there is a plurality of fuel cells. In this particular embodiment, there are ten fuel cells. FIG. 5, for simplicity, shows just the elements of one fuel cell. Thus, there is shown in FIG. 5 an anode flow field plate 120, a first or anode gas diffusion layer or media 122, a MEA 124, a second or cathode gas diffusion layer 126 and a cathode flow field plate 130.

To hold the assembly together, tie rods 131 are provided, which are screwed into threaded bores in the anode endplate 102, passing through corresponding plain bores in the cathode endplate 104. In known manner, nuts and washers are provided, for tightening the whole assembly and to ensure that the various elements of the individual fuel cells are clamped together.

Now, the present invention is concerned with the seals and the method of forming them. As such, it will be understood that other elements of the fuel stack assembly can be largely conventional, and these will not be described in detail. In particular, materials chosen for the flow field plates, the MEA and the gas diffusion layers are the subject of conventional fuel cell technology, and by themselves, do not form part of the present invention.

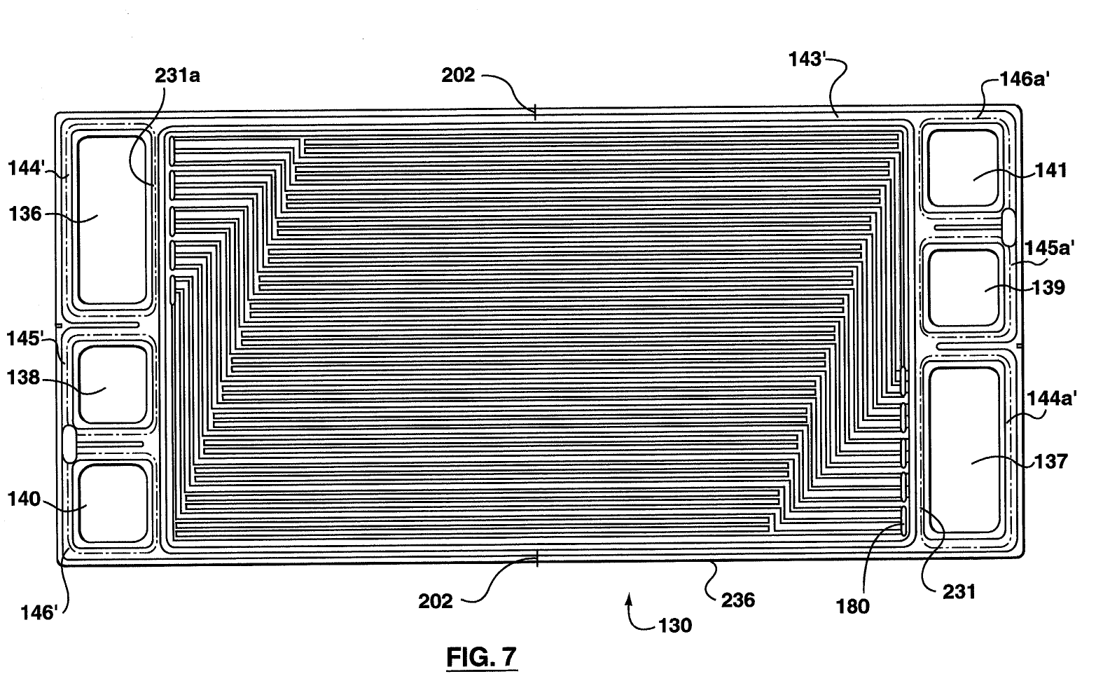

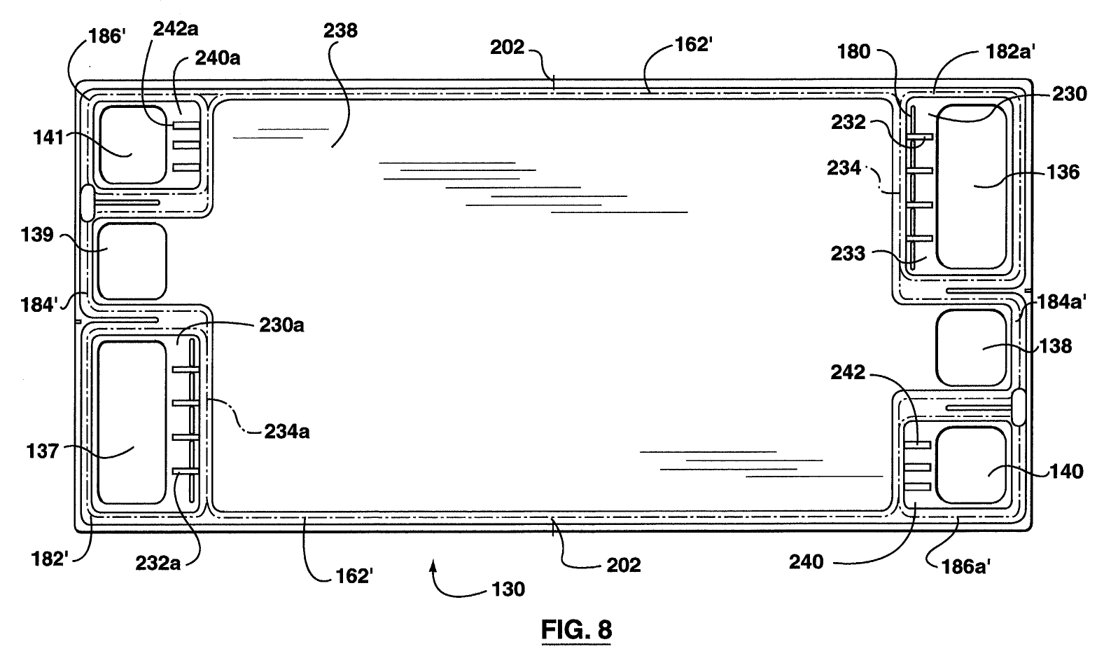

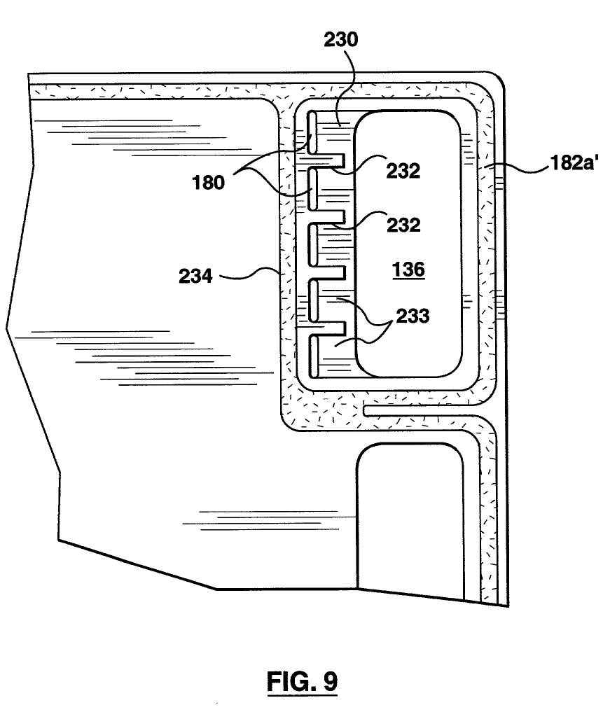

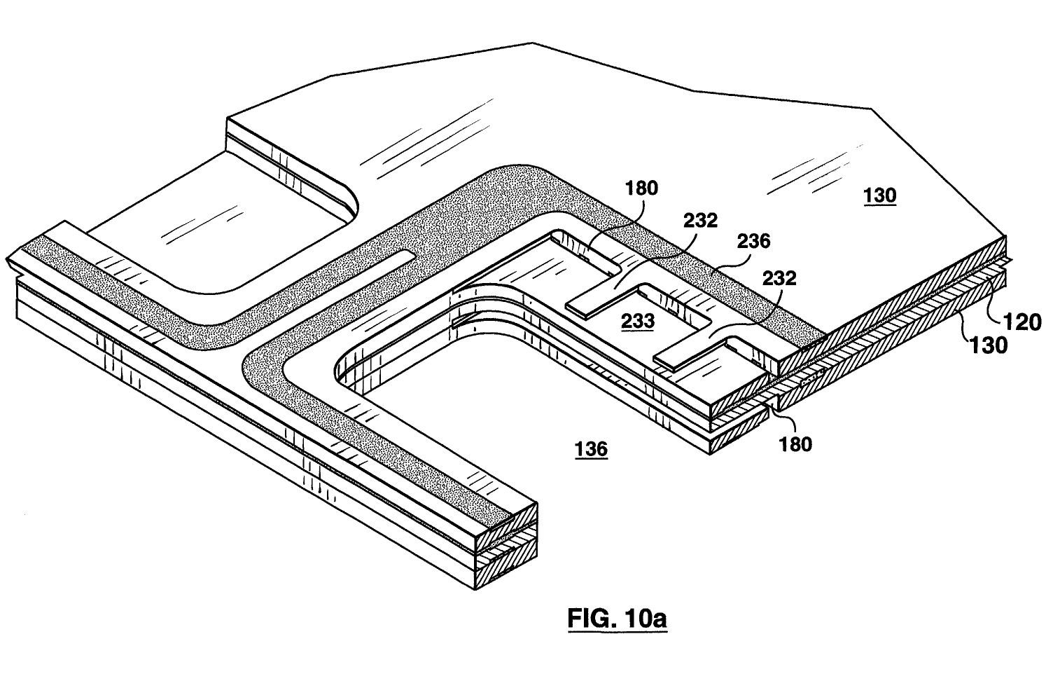

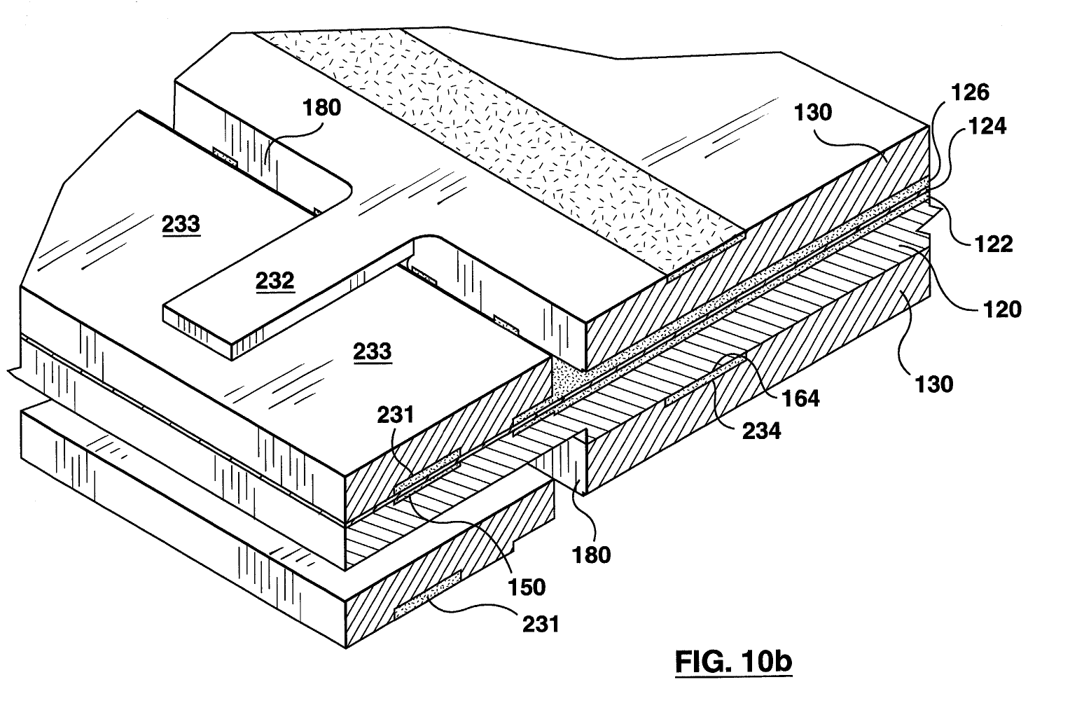

In the following description, it is also to be understood that the designations “front” and “rear” with respect to the anode and cathode flow field plates 120, 130, indicates their orientation with respect to the MEA. Thus, “front” indicates the face towards the MEA; “rear” indicates the face away from the MEA. Consequently, in FIGS. 9 and 10, the configuration of the ports is reversed as compared to FIGS. 7 and 8.

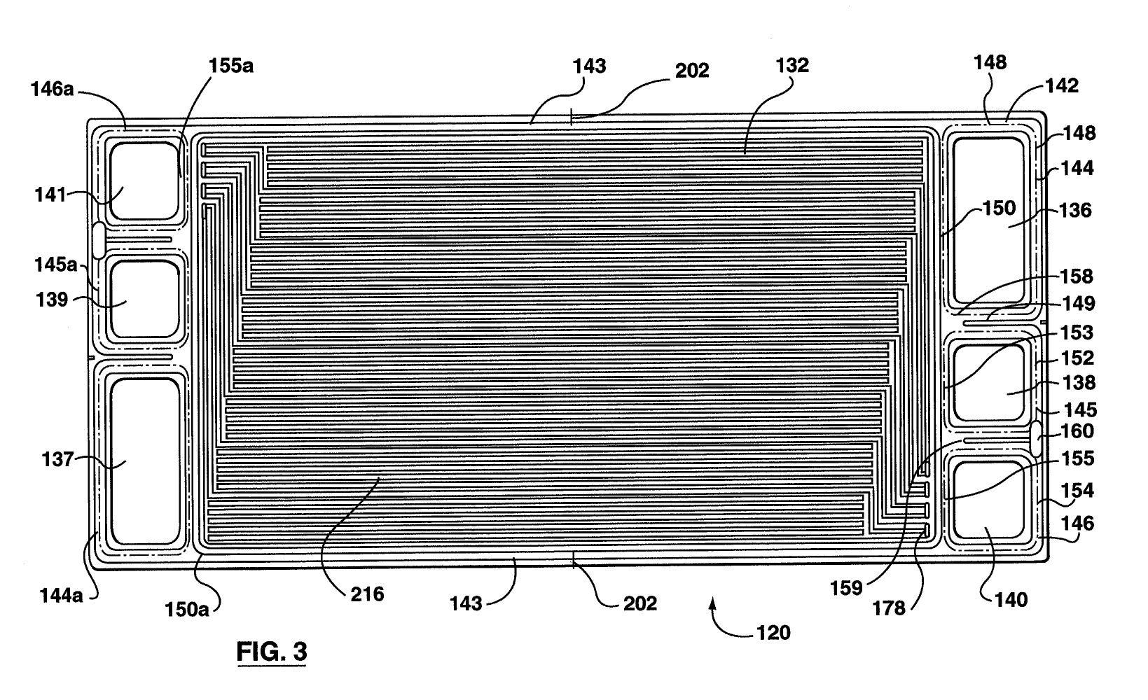

Reference will now be made to FIGS. 3 to 6, which show details of the anode bipolar plate 120. As shown, the plate 120 is generally rectangular, but can be any geometry, and includes a front or inner face 132 shown in FIG. 7 and a rear or outer face 134 shown in FIG. 8. The front face 132 provides channels for the hydrogen, while the rear face 134 provides a channel arrangement to facilitate cooling.

Corresponding to the ports 106-111 of the whole stack assembly, the flow field plate 120 has rectangular apertures 136, 137 for air flow; generally square apertures 138, 139 for coolant flow; and generally square apertures 140, 141 for hydrogen. These apertures 136-141 are aligned with the ports 106-111. Corresponding apertures are provided in all the flow field plates, so as to define ducts or distribution channels extending through the fuel cell stack in known manner.

Now, to seal the various elements of the fuel cell stack 100 together, the flow field plates are provided with grooves to form a groove network, that, as detailed below, is configured to accept and to define a flow of a sealant that forms seal through the fuel cell stack. The elements of this groove network on either side of the anode flow field plate 120 will now be described.

On the front face 132, a front groove network or network portion is indicated at 142. The groove network 142 has a depth of 0.024″ and the width varies as indicated below.

The groove network 142 includes side grooves 143. These side grooves 143 have a width of 0.153″.

At one end, around the apertures 136, 138 and 140, the groove network 142 provides corresponding rectangular groove portions.

Rectangular groove portion 144, for the air flow 136, includes outer groove segments 148, which continue into a groove segment 149, all of which have a width of 0.200″. An inner groove segment 150 has a width of 0.120″. For the aperture 138 for cooling fluid, a rectangular groove 145 has groove segments 152 provided around three sides, each again having a width of 0.200″. For the aperture 140, a rectangular groove 146 has groove segments 154 essentially corresponding with the groove segments 152 and each again has a width of 0.200″. For the groove segments 152, 154, there are inner groove segments 153, 155, which like the groove segment 150 have a width of 0.120″.

It is to be noted that, between adjacent pairs of apertures 136, 138 and 138, 140, there are groove junction portions 158, 159 having a total width of 0.5″, to provide a smooth transition between adjacent groove segments. This configuration of the groove junction portion 158, and the reduced thickness of the groove segments 150, 153, 155, as compared to the outer groove segments, is intended to ensure that the material for the sealant flows through all the groove segments and fills them uniformly.

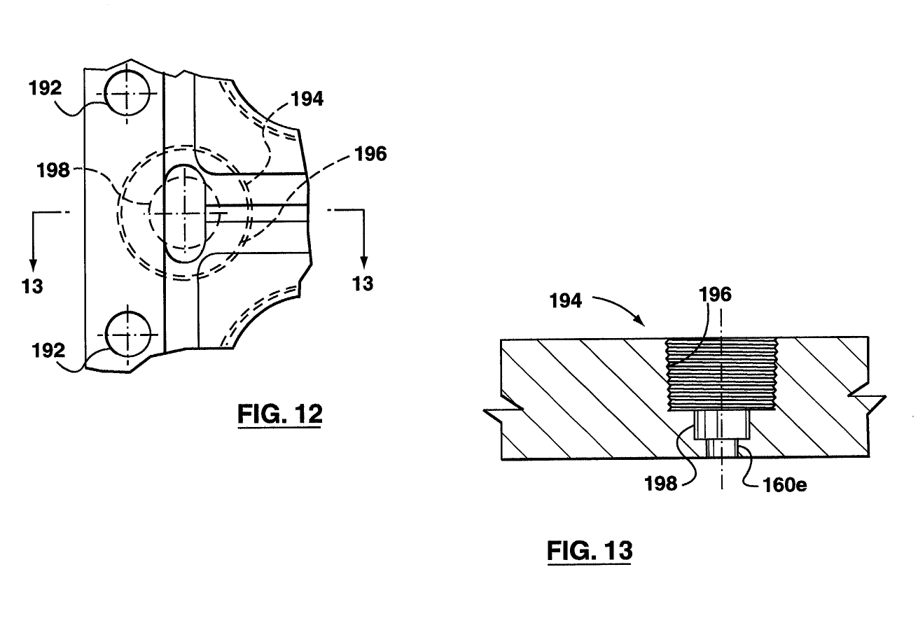

To provide a connection through the various flow field plates and the like, a connection aperture 160 is provided, which has a width of 0.25″, rounded ends with a radius of 0.125″ and an overall length of 0.35″. As shown, in FIG. 3, the connection aperture 160 is dimensioned so as clearly intercept the groove segments 152, 154. This configuration is also found in the end plates, insulators and current collection plates, as the connection aperture 160 continues through to the end plates and the end plates have a corresponding groove profile. It is seen in greater detail in FIGS. 12 and 16, and is described below.

The rear seal profile of the anode flow field plate is shown in FIG. 8. This includes side grooves 162 with a larger width of 0.200″, as compared to the side grooves on the front face. Around the air aperture 136, there are groove segments 164 with a uniform width also of 0.200″. These connect into a first groove junction portion 166.

For the coolant aperture 138, groove segments 168, also with a width of 0.200″, extend around three sides. As shown, the aperture 138 is open on the inner side to allow cooling fluid to flow through the channel network shown. As indicated, the channel network is such as to promote uniform distribution of cooling flow across the rear of the flow field plate.

For the fuel or hydrogen aperture 140 there are groove segments 170 on three sides. A groove junction portion 172 joins the groove segments around the apertures 138, 140.

An innermost groove segment 174, for the aperture 140 is set in a greater distance, as compared to the groove segment 155 This enables flow channels 176 to be provided extending under the groove segment 155. Transfer slots 178 are then provided enabling flow of gas from one side of the flow field plate to the other. As shown in FIG. 3, these slots emerge on the front side of the flow field plate, and a channel network is provided to distribute the gas flow evenly across the front side of the plate. The complete rectangular grooves around the apertures 136, 138 and 140 in FIG. 8 are designated 182, 184 and 186 respectively.

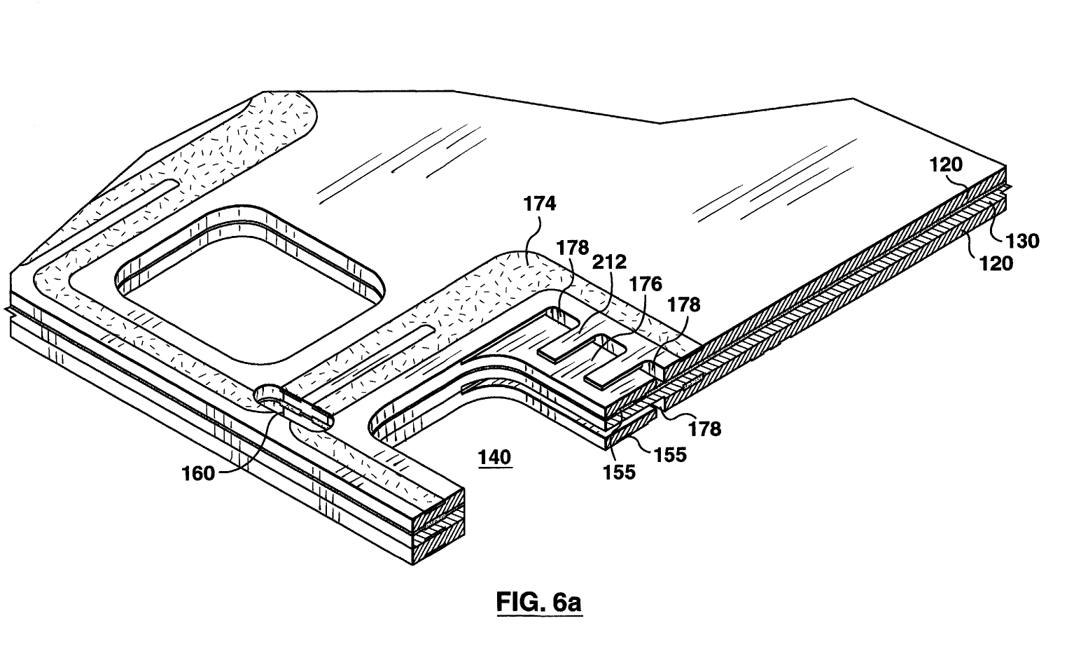

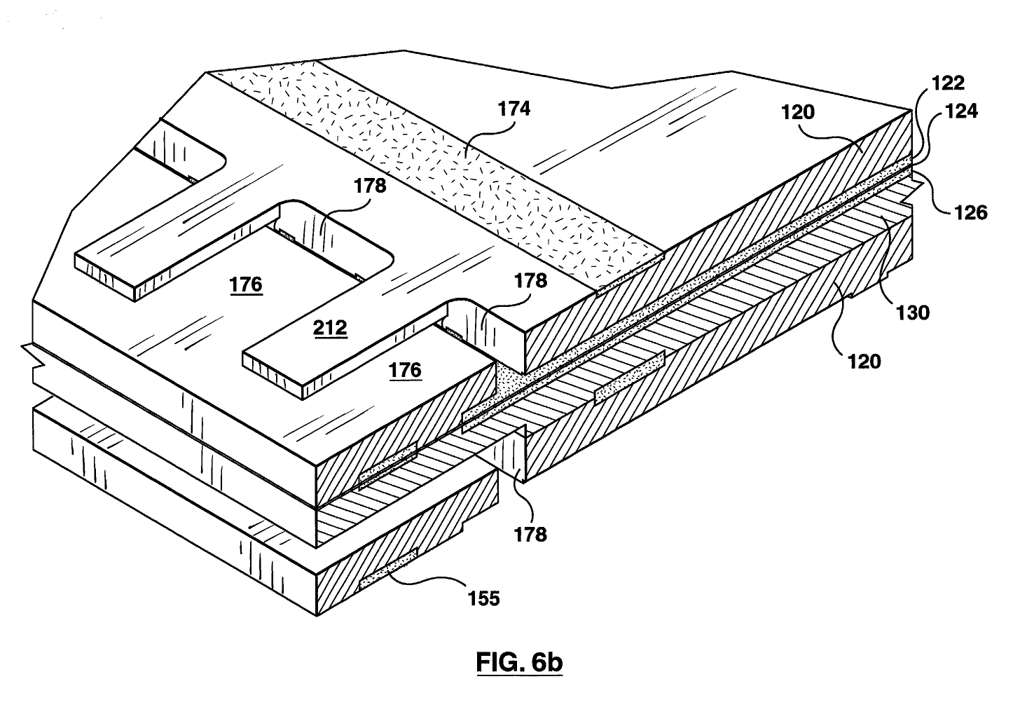

FIGS. 5 and 6 show details of the flow channels around the aperture 140, and FIG. 6 additionally shows the complementary effect of the anode and cathode flow field plates 120, 130. As detailed below in relation to FIGS. 7-10, the cathode flow field plate provides, on its rear side, projections 242 separating flow channels 240. These projections 242 complement the projections 212, and sandwich an MEA therebetween; similarly the channels 240 complement the channels 176. As the projections 212, 242 do not reach the edge of the aperture 140, the view of FIG. 6 shows a slot between the plates 120, 130 for directing fuel gas through the flow channels 176, 242 to the slots 178.

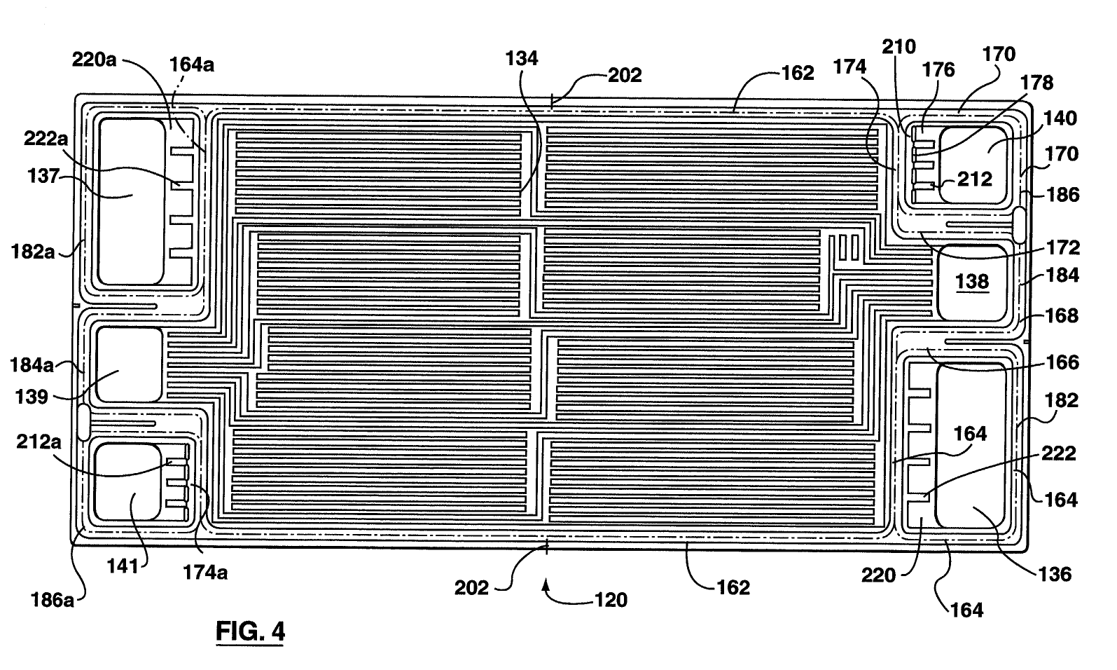

As shown in FIGS. 3 and 4, the configuration for the apertures 137, 139 and 141 at the other end of the anode flow field plate 120 corresponds. For simplicity and brevity the description of these channels is not repeated. The same reference numerals are used to denote the various groove segments, junction portions and the like, but with a suffix “a” to distinguish them, e.g. for the groove portions 144a, 145a and 146a, in FIG. 3.

Reference is now being made to FIGS. 7 to 10, which show the configuration of the cathode flow field plate 130. It is first to be noted that the arrangement of sealing grooves essentially corresponds to that for the anode flow field plate 120. This is necessary, since the design required the MEA 124 to be sandwiched between the two flow field plates, with the seals being formed exactly opposite one another. It is usually preferred to design the stack assembly so that the seals are opposite one another, but this is not essential. It is also to be appreciated that the front side seal path (grooves) of the anode and cathode flow field plates 120, 130 are mirror images of one another, as are their rear faces. Accordingly, again for simplicity and brevity, the same reference numerals are used in FIGS. 7 to 10 to denote the different groove segments of the sealing channel assembly, but with an apostrophe to indicate their usage on the cathode flow field plate.

Necessarily, for the cathode flow field plate 130, the groove pattern on the front face is provided to give uniform distribution of the oxidant flow from the oxidant apertures 136, 137. On the rear side of the cathode flow field plate transfer slots 180 are provided, providing a connection between the apertures 136, 137 for the oxidant and the network channels on the front side of the plate. Here, five slots are provided for each aperture, as compared to four for the anode flow field plate. In this case, as is common for fuel cells, air is used for the oxidant, and as approximately 80% of air comprises nitrogen, a greater flow of gas has to be provided, to ensure adequate supply of oxidant.

On the rear of the cathode flow field plate 130, no channels are provided for cooling water flow, and the rear surface is entirely flat. Different depths are used to compensate for the different lengths of the flow channels and different fluids within. However, the depths and widths of the seals will need to be optimized for each stack design.

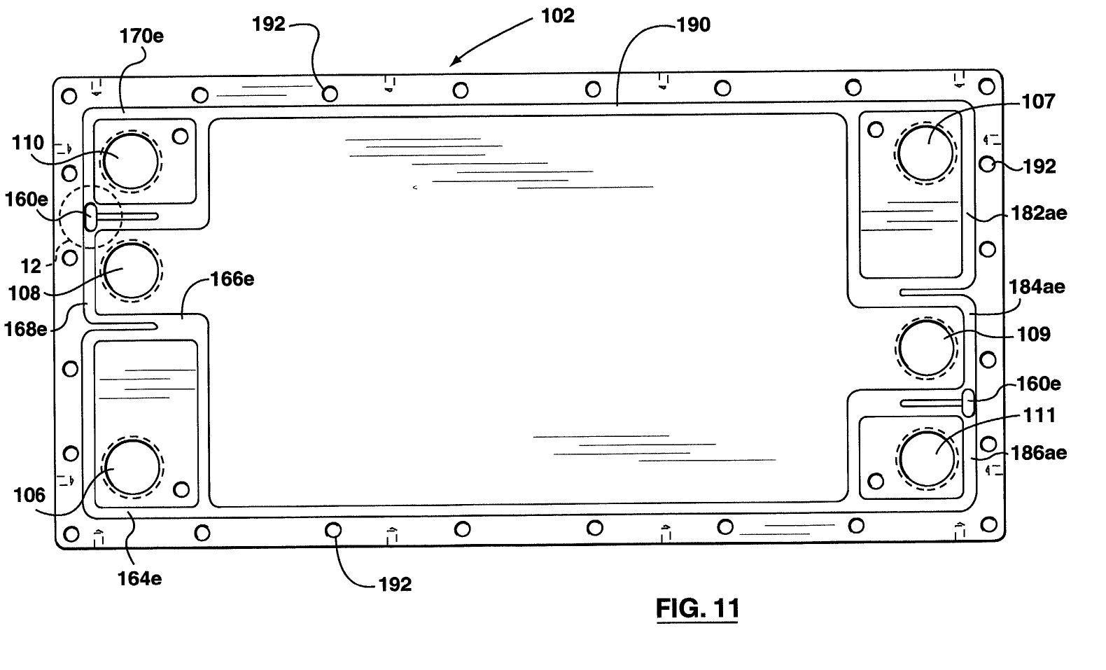

FIGS. 9 and 10, like FIGS. 5 and 6, show details of the flow channels connecting the apertures 136 to the slots 180. There, the projections 222 (FIG. 4) and 232 also stop short of the edge of the aperture 136, and hence are not visible in FIG. 10. The projections 222 and 232 abut one another so as to provide support for grooves of the groove network for the seal. The flow channels 220, 233, then complement one another and provide flow passages between the apertures 136 and the slots 180, but at the same time are maintained separated by the MEA Reference will now be made to FIGS. 11 through 15, which show details of the anode and cathode end plates. These end plates have groove networks corresponding to those of the flow field plates.

Thus, for the anode end plate 102, there is a groove network 190, that corresponds to the groove network on the front face of the anode flow field plate 120. Accordingly, similar reference numerals are used to designate the different groove segments of the anode and anode end plates 102, 104 shown in detail in FIGS. 11-13 and 14-15, but identified by the suffix “e”. As indicated at 192, threaded bores are provided for receiving the tie rods 132.

Now, in accordance to the present invention, a connection port 194 is provided, as best shown in FIG. 13. The connection port 194 comprises a threaded outer portion 196, which is drilled and tapped in known manner. This continues into a short portion 198 of smaller diameter, which in turn connects with the connection aperture 160e. However, any fluid connector can be used.

Corresponding to the flow field plates, for the anode end plate 102, there are two connection ports 194, connecting to the connection apertures 160e and 160ae, as best shown in FIGS. 12 and 13.

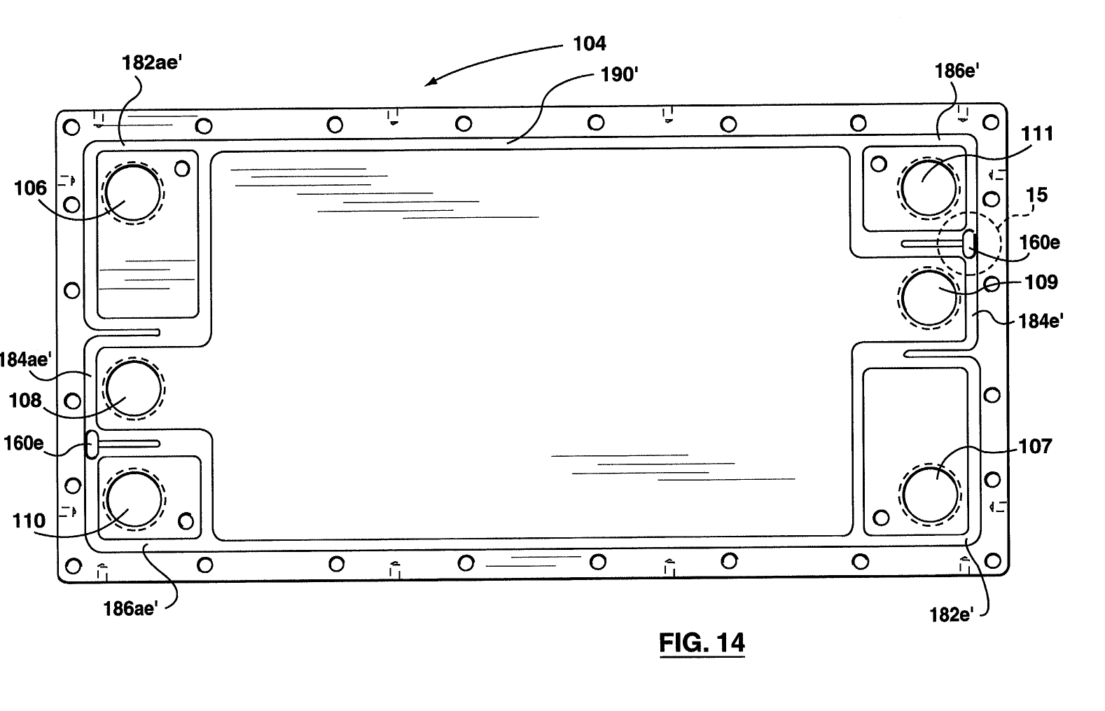

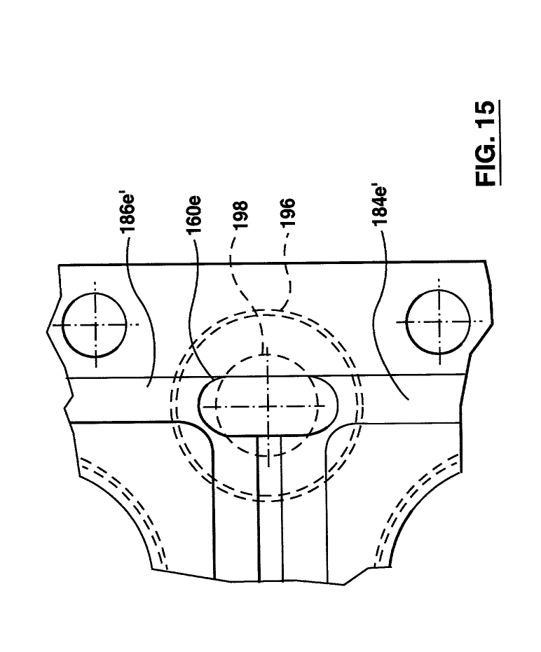

Correspondingly, the cathode end plate is shown in detail in FIGS. 14 and 15, with FIG. 15, as FIG. 12, showing connection through to the groove segments. The groove profile on the inner face of the cathode end plate corresponds to the groove profile of the anode flow field plate. As detailed below, in use, this arrangement enables a seal material to be supplied to fill the various seal grooves and channels. Once the seal has been formed, then the supply conduits for the seal material are removed, and closure plugs are inserted, such closure plugs being indicated at 200 in FIG. 5

Now, the seals of the present invention can be conventional gaskets, or seals formed by injecting liquid silicone rubber material into the various grooves between the different elements of the fuel stack, as disclosed and claimed in U.S. patent application Ser. No. ______.

In use, the fuel cell stack 100 is assembled with the appropriate number of fuel cells and clamped together using the tie rods 131. The stack would then contain the elements listed above for FIG. 5, and it can be noted that, compared to conventional fuel cell stacks, there are, at this stage, no seats between any of the elements. However insulating material is present to shield the anode and cathode plates touching the MEA (to prevent shorting) and is provided as part of the MEA. This material can be either part of the lonomer itself or some suitable material (fluoropolymer, mylar, etc.). An alternative is that the bipolar plate is nonconductive in these areas.

If any leaks are detected, the fuel cell will most likely have to be repaired. The fuel cell stacks can have a wide range for the number of fuel cells in the stack. The number of cells can vary from one to a hundred, or conceivably more. Where, individual cells can be robustly sealed and/or seals can be readily replaced, this may have advantages The fuel cells can be sealed using a seal in place technique disclosed in co-pending U.S. patent application Ser. No. ______.

Also, fuel cell stacks with a single fuel cell or only a few fuel cells can be formed and these may require more inter-stack connections, but it is intended that this will be more than made up for by the inherent robustness of reliability of each individual fuel cell stack. The concept can be applied all the way down to a single cell unit (identified as a Membrane Electrode Unit or MEU) and this would then conceivably allow for stacks of any length to be manufactured.

This MEU is preferably formed so a number of such MEU's to be readily and simply clamped together to form a complete fuel cell stack of desired capacity. Thus, an MEU would simply have flow field plates, whose outer or rear faces are adapted to mate with corresponding faces of other MEU's, to provide the necessary functionality. Typically, faces of the MEU are adapted to form a coolant chamber of cooling fuel cells. One outer face of the MEU can have a seal or gasket preformed with it. The other face could then be planar, or could be grooved to receive the preformed seal on the other MEU. This outer seal or gasket can be formed simultaneously with the formation of the internal seal, injected-in-place in accordance with U.S. patent application Ser. No. ______. For this purpose, a mold half can be brought up against the outer face of the MEU, and seal material can then be injected into a seal profile defined between the mold half and that outer face of the MEU, at the same time as the seal material is injected into the groove network within the MEU itself. To form a complete fuel cell assembly, it is simply a matter of selecting the desired number of MEU's, clamping the MEU's together between endplates, with usual additional end components, e.g. insulators, current collectors, etc. The outer faces of the MEU's and the preformed seals will form necessary additional chambers, especially chambers for coolant, which will be connected to appropriate coolant ports and channels within the entire assembly. This will enable a wide variety of fuel cell stacks to be configured from a single basic unit, identified as an MEU It is noted, the MEU could have just a single cell, or could be a very small number of fuel cells, e.g. 5. In the completed fuel cell stack, replacing a failed MEU, is simple. Reassembly only requires ensuring that proper seals are formed between adjacent MEU's and seals within each MEU are not disrupted by this procedure.

Referring to FIGS. 3-6, these show details of the gas flow arrangement in accordance with the present invention, for the anode flow field plate. Firstly, it is to be noted that the front of the anode flow field plate, generally indicates at 132, all of the apertures 136-141 are closed off from the flow channels. To provide flow of hydrogen, fuel gas, the transfer slots 178 are provided, extending through to the rear or backside of the anode flow field plate 120. As shown in FIGS. 3, 4, 5 and 6, each of the apertures 140, 141 includes an aperture extension 210 that extends under the inner grooves segments 155, 155a. The groove network 142 on the front face includes groove portions on sealing surface portion that enclose the apertures 140, 141, and separate them from a main active area including the slots 178. On the rear side, groove portions or sealing surface portions enclose both the apertures 140, 141 and the slots 178 Each of these aperture extensions includes projections 212, defining flow channels 214, providing communication between the respective aperture 140, 141 and the transfer slots 178.

The numerous groove segments 174, for the seal or gasket, are then offset, as best shown in FIG. 6, i.e. they are not located directly opposite the groove segments 155, 155a. The result of this is that on the rear side, the slots 178 are connected by the flow channels 176 to the apertures 140, 141; on the front face, the transfer slots 178 open directly into flow channels 216 of the active area extending across the front face.

As shown, flow channels 218 are provided for coolant on the rear face, extending between the apertures 138, 139.

The projections 212 are provided to ensure adequate support for the portion of the plate 120 forming the grooves segments 155, 155a. As detailed below, corresponding projections 242 are provided on the rear of the cathode flow field plate 130, and all these projections are flush with the surface of the respective flow field plates, so that the projections 212, 242 abut one another, to support the respective groove segments.

For the apertures 136, 137 for flow of air or other oxidant, again, aperture extensions 220 are provided. Corresponding to the apertures 140, 141 these extensions 220 extend under the groove segments 150, 150a to provide support for them. Rear groove segments 164, 164a on the rear face of the plate 120 are then offset inwardly. Corresponding to the projections 212, projections 222 are provided, complementing the projections on the cathode flow field plate, as detailed below.

Referring now to the cathode flow field plate 130, the detailed structure in general corresponds to that of the anode flow field plate 120.

Thus, aperture extensions 230 are provided for the apertures 136, 137 of the cathode plate 130. On the front of the cathode flow field plate, all of the apertures 136-141 are closed off, and for the apertures 136, 137 inner groove segments 231 are provided. Transfer slots 180 are provided connecting the fluid flow channels on the front face indicated at 236 to the rear face On the rear face, the aperture extensions 230 include projections 232 defining flow channels 233, providing communication between the aperture 136, 137 and the transfer slots 180, and supporting the groove segments 231.

As for the anode plate, groove segments 234, 234a are offset relative to the groove segments 231, 231a.

The projections 232, 232a complement the projections 222, 222a of the anode flow field plate, for supporting the membrane. This provides two functions. Firstly, as noted, it provides support for each groove segment 231.

Flow channels 238 are provided on the rear, in communication with the ports 138, 139, again for cooling purposes. The flow channel would complement that on the rear of the anode flow field plate, for efficient flow of coolant, or could simply be open with no defined channels.

As FIG. 8 shows, again to complement the anode flow field plate 120, the apertures 140, 141 of the cathode flow field plate 130 are provided with an aperture extensions 240, 240a including projections 242, 242a. These projections complement the projections 212, 212a. In a like manner, this arrangement provides support for the anode flow field plate.

Turing now to FIGS. 11 and 14, these show rear views of the anode and cathode end plates 102, 104 As shown, these are provided with sealed configurations, indicated by groove network 190 on FIG. 11 and 190′ on FIG. 14.

As shown, on each of the end plates 102, 104, the ports 106, 107, 110 and 111 open into chambers, provided with extensions indicated at 240. These extensions 240 corresponded to the aperture extensions 210, 220, 230, 240 on the anode and cathode flow field plates 120, 130. Ports 108, 109 open into a main chamber provided with flow channels for the coolant, again with a pattern corresponding to the flow pattern on the rear of the anode and cathode flow field plates 120, 130 respectively.

While the invention is described in relation to proton exchange membrane (PEM) fuel cell, it is to be appreciated that the invention has general applicability to any type of fuel cell. Thus, the invention could be applied to: fuel cells with alkali electrolytes; fuel cells with phosphoric acid electrolyte; high temperature fuel cells, e.g. fuel cells with a membrane similar to a proton exchange membrane but adapted to operate at around 200° C.; electrolysers, regenerative fuel cells.

1. A flow field plate for a fuel cell, the flow field plate having a front side, for defining a chamber with a complementary flow field plate for a membrane electrode assembly, and a rear side, the flow field plate including:
at least two apertures for a reactant gas for supply to said chambers;
on the front side thereof, reactant gas flow field channels;
for each of the apertures, an aperture extension extending on the rear side of the flow field plate;
for each aperture, at least one slot extending through the flow field plate from the back side to the front side thereof, to provide communication between the corresponding aperture extension and the reactant action gas flow channels.

2. A flow field plate as claimed in claim 1 which includes sealing surfaces on the front and rear sides, for forming a seal with adjacent elements of fuel cell, wherein the sealing surface on the front side of includes, for each aperture, a first sealing surface portion enclosing the corresponding aperture and separating at least one slot from the corresponding aperture and on the rear side thereof, a second sealing surface portion enclosing together said at least one slot and the aperture.

3. A flow field plate as claimed in claim 2, which includes, for each of the aperture, a plurality of slots.

4. A flow field plate as claimed in claim 3, wherein each aperture extension is provided with a plurality of projections, defining flow channels extending from the apertures to the slots.

5. a flow field plate as disclaimed in claim 3, which includes:
at least two second apertures for a second reactant gas;
on the front side thereof, for each second aperture, a second aperture extension and a plurality of second projections provided in the second aperture extension, for abutting complementary projections of a second flow field plate for the second reactant gas.

6. A flow field plate as claimed in claim 5, which includes, on the rear thereof, for each second aperture a rear sealing portion enclosing the corresponding second aperture and on the front thereof, a second, front sealing portion enclosing the corresponding second aperture and associated second aperture extension, wherein the second front and rear sealing portions include sealing surface segments offset from one another.

7. A flow field plate as claimed in claim 6, wherein each sealing surface portion comprises a groove for receiving a seal.

8. A flow field plate as claimed in claim 6 or 7 which includes at least two third apertures for a coolant flow; on the rear side thereof, flow channels providing flow paths between the third apertures for the coolant; and on the front thereof sealing portions enclosing the third apertures.

9. A fuel cell assembly including at least one fuel cell, wherein each fuel cell comprises:
first and second complementary flow field plates including a front sides and rear side, with the front surfaces facing one another and defining a fuel cell chamber;
a membrane electrode assembly and gas diffusion media provided within the fuel cell chamber;
at least two first apertures in each flow field plate for a first reactant gas and at least two second apertures in each flow field plate for a second reactant gas;
wherein the first flow field plate includes: first reactant gas flow channels on the front side thereof; first slots extending from the first reactant gas flow channels to the rear side thereof; for each of the first apertures thereof, on the rear site thereof, a first aperture extension, providing communication between the first apertures thereof and said first slots; and
wherein the second flow field plate includes: second reactant gas flow channels on the front side thereof; second slots extending from the second reactant gas flow channels to the rear side thereof; for each of the second apertures thereof, on the rear side thereof, a second aperture extension, providing communication between the second apertures thereof and said second slots.
